(19) United States
(12) Patent Application Publication
(10) Pub. No.: US 2025/0315824 A1
(43) Pub. Date: Oct. 9, 2025

(54) SYSTEMS AND METHODS FOR EMOTIONALLY ADAPTIVE FINANCIAL CHATBOT

(71) Applicant: Wells Fargo Bank, N.A., San Francisco, CA (US)

(72) Inventors: Sujay Katgeri, Allen, TX (US); Phani N. Kidambi, Lee, NH (US)

(21) Appl. No.: 18/625,789

(22) Filed: Apr. 3, 2024

(51) Int. Cl. G06Q 20/40; G06V 10/82; G06V 40/16; G10L 15/183; G10L 25/30; G10L 25/63

(52) U.S. Cl. CPC G06Q 20/401

(57) ABSTRACT

Various examples are directed to systems and methods for emotionally adaptive financial chatbots. A method includes receiving authentication information from a user of the computer system, authenticating the user for a transaction based on the received authentication information, and detecting an abnormal aspect of the transaction based on parameters of the transaction. Upon detecting the abnormal aspect, the method includes determining, using machine learning, an emotional state of the user. The method further includes adapting an interaction style with the user based on the determined emotional state of the user, receiving an input from the user after adapting the interaction style, and implementing additional security requirements for the transaction based on the detected abnormal aspect, the input from the user, and the determined emotional state.

### TECHNICAL FIELD

This document relates generally to computer systems and more particularly to systems and methods for emotionally adaptive financial chatbots.

### BACKGROUND

A virtual assistant or chatbot may be employed to assist one or more users with accessing or using a computer system. In one example, financial computer systems may use chatbots to aid with user transactions or interactions. Traditional financial chatbots focus mainly on transaction efficiency and information provision. However, traditional financial chatbots lack the capability to understand and respond to the emotional states of users which may impact their financial decisions. Improved systems and methods for emotionally adaptive financial chatbots are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates an example embodiment of a method for emotionally adaptive financial chatbots, according to various embodiments;

FIG. 2 illustrates an exemplary infrastructure for use in the present subject matter, according to various embodiments;

FIG. 3 illustrates an example machine learning system for emotionally adaptive financial chatbots, according to various embodiments;

FIG. 4 illustrates a flowchart of a method of training a model for emotionally adaptive financial chatbots, according to various embodiments;

FIG. 5 illustrates a block diagram of a system for emotionally adaptive financial chatbots, according to various embodiments;

FIG. 6 illustrates a flow diagram of an emotionally adaptive system using facial features, according to various embodiments;

FIG. 7 illustrates a flow diagram of an emotionally adaptive system using speech features, according to various embodiments; and

FIG. 8 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

A virtual assistant or chatbot may be employed to assist one or more users with accessing or using a computer system. In one example, financial computer systems may use chatbots to aid with user transactions or interactions. Traditional financial chatbots focus mainly on transaction efficiency and information provision. However, traditional financial chatbots lack the capability to understand and respond to the emotional states of users which may impact their financial decisions. Improved systems and methods for emotionally adaptive financial chatbots are needed.

The present subject matter provides systems and methods for emotionally adaptive chatbots or virtual assistants using machine learning, such as artificial intelligence, according to various embodiments. The present systems and methods are demonstrated with computer systems for financial institutions, but may be used for any computer systems with user interaction where the system may adapt to the user's emotional state.

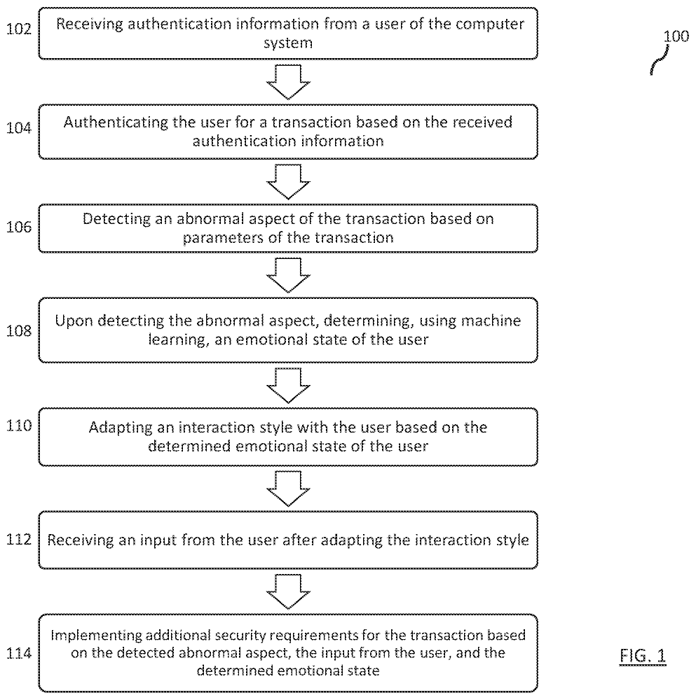

FIG. 1 illustrates an example embodiment of a method for emotionally adaptive financial chatbots, according to various embodiments. A computer-implemented method 100 includes receiving authentication information from a user of the computer system, at step 102, authenticating the user for a transaction based on the received authentication information, at step 104, and detecting an abnormal aspect of the transaction based on parameters of the transaction, at step 106. At step 108, upon detecting the abnormal aspect, the method includes determining, using machine learning, an emotional state of the user. The method 100 further includes adapting an interaction style with the user based on the determined emotional state of the user, at step 110. At step 112, the method 100 includes receiving an input from the user after adapting the interaction style. The method 100 also includes implementing additional security requirements for the transaction based on the detected abnormal aspect, the input from the user, and the determined emotional state, at step 114.

According to various embodiments, determining the emotional state of the user includes using voice analysis. Determining the emotional state of the user includes analyzing voice tone of the user, in some embodiments. In various examples, determining the emotional state of the user includes analyzing speech patterns of the user. Determining the emotional state of the user includes using computer vision, in some examples. In various examples, determining the emotional state of the user includes analyzing facial expressions of the user, such as those obtained using computer vision. Determining the emotional state of the user includes analyzing body language of the user, such as obtained using a camera or computer vision, in some embodiments. According to various embodiments, the machine learning includes artificial intelligence (AI). The artificial intelligence includes a large language model (LLM), in some embodiments.

In various examples, implementing additional security requirements for the transaction includes limiting an amount of the transaction. Implementing additional security requirements for the transaction includes delaying the transaction, in some examples. In various embodiments, implementing additional security requirements for the transaction includes implementing an additional security review of the transaction. Implementing additional security requirements for the transaction includes providing a notification to the user, in some embodiments.

According to various embodiments, the present subject matter not only adapts how a virtual assistant interacts with a user (also referred to herein as a customer) based on detected emotional state, but rather enhances the security parameters and guardrails in place for actions the customer is attempting to perform based on their detected emotional state. For example, the action could be a transaction (e.g., “send $100 to John”), the opening of a new account, adding an authorized user, etc. In one example, the present system may be used with an online payment or transaction system, such as Zelle®, Venmo®, or CashApp®. In each of these situations, the customer is already authenticated through standard means (e.g., username and password, biometric, etc.) in a digital environment (mobile or web) and is providing instructions to a virtual assistant. In various examples, the present system analyzes the request for “out of the norm” or abnormal situations, such as sending money to a new recipient, something that changes access to account, etc. The system then analyzes and determines an emotional state of the customer (are they angry, stressed, inebriated, etc.?) using machine learning, in various embodiments. Based on the combination of out of norm situations and user emotional state, the system can implement additional security parameters and guardrails for the request, in various examples. Additional security parameters may include, but are not limited to, limiting the amount of a transaction, delaying the transaction, implementing an additional security review, or alerting the user that something is abnormal.

The present subject matter provides an emotionally adaptive financial chatbot with enhanced voice and facial emotion recognition, in various embodiments. The present system provides enhanced security and fraud protection, as well as regulating how the virtual assistant (or chatbot) formulates its responses during the conversation with the customer. For example, if the user or customer is upset, or in a high tense state, the system will help prevent the user from performing a financial action that the user may regret at a later time.

The present subject matter may be applied in the field of financial technology and artificial intelligence, by providing a sophisticated chatbot system for digital banking platforms equipped with voice and facial emotion recognition capabilities. This system is designed to enhance user interaction and ensure safer financial transactions based on the emotional state of the user.

Traditional financial chatbots lack the capability to understand and respond to the emotional states of users, which is needed given the significant impact of emotions on financial decisions. The present subject matter introduces an emotionally intelligent financial chatbot equipped with both voice and computer vision technology to detect and respond to users' emotional states. The system is designed to adapt its interaction style according to the detected mood of the user, whether positive or negative, and implement safeguard mechanisms for financial transactions during emotionally heightened states.

In various embodiments, the present system includes a detection component that employs advanced voice recognition and facial emotion recognition technologies to ascertain the user's emotional state. The system analyzes voice tone, speech patterns, facial expressions, and body language, in various embodiments. In some embodiments, the present system provides for adaptive interaction with the user based on the user's emotional state. For example, depending on the detected emotion, such as distress, happiness, anger, fear, anxiety, inebriation, or other emotions, the chatbot modifies its interaction style. For positive emotions, it mirrors the user's happiness with a cheerful tone, while for negative emotions, it adopts a supportive and empathetic tone, in various examples. For example, if the user is determined by the system to be angry, an additional chatbot may be used to tone down the emotional state. In another example, voice analysis may indicate a person is inebriated or tipsy, and the chatbot may be adjusted accordingly. Thus, the present system may function like a coach or therapist, reading the speech, face, and/or body language and adjusting responses to bring focus back for the customer or user.

In some embodiments, the present system may use information related to a cultural background of a user to determine a user's emotional state or to govern chatbot behavior. For example, if a heightened emotional state of the user is determined, the present system may use generative AI to coach or counsel the user to reduce agitation based on their cultural background. In another example, the present system may be used to calm a user down, and provide different ways to deal with agitated states of the user, such as tone, content, style, and the like.

In various embodiments, the present system provides an enhanced transaction safeguard system based on the user's emotional state. For example, when heightened emotional states of users are detected, the system introduces additional verification steps for financial transactions, especially for those that are unusual or involve new contacts, to prevent impulsive financial decisions by the user. For example, the user may be prompted to provide a portion of their social security number as an additional safeguard. The present system may be used to protect against scams, in various embodiments. For example, a second factor of authentication may be used if a phone number provided matches a phone number used in a previous scam. In one example, a peer-to-peer network may be used among institutions to share information and help identify phone numbers used in previous scams.

According to various examples, the present system provides an operational methodology that activates the chatbot upon a user's initiation, either through voice command or visual recognition. The present system uses an emotion detection component to process the user's speech and facial expressions to assess their emotional state, in various examples. In various embodiments, the present system uses an adaptive interaction mechanism to adjust the chatbot's response style to align with the user's mood. In cases of heightened emotional states, the present system provides an enhanced transaction safeguard system to ensure a rigorous verification process for financial transactions, in various embodiments.

The present system may use voice recognition technology together with advanced algorithms for processing diverse accents and speech patterns, in some embodiments. In various examples, the present system uses facial emotion recognition technology, such as computer vision algorithms trained to recognize a range of facial expressions and body language cues. In some embodiments, the present system uses Natural Language Processing (NLP) for nuanced understanding and generation of conversational responses for the chatbot. In various examples, the present system uses security protocols such as strong encryption and security measures to ensure the protection of sensitive user data and financial information.

The present system provides a financial chatbot with enhanced emotion recognition. The system may be equipped with both voice and facial emotion recognition technologies to accurately detect the user's emotional state. The system may provide for adaptive interaction based on an emotional assessment, thus providing the ability of the chatbot to alter its interaction style in response to the emotional cues identified through voice, body and facial analysis. In various embodiments, the system provides a robust transaction safety mechanism in emotional states, thus providing a safeguard feature that introduces additional steps in transaction processing during periods of user emotional vulnerability.

The present system provides for a comprehensive emotional state review, with heightened identification when a financial transaction is out of the norm, providing additional safeguards for modifying or denying the transaction when an emotional state is detected. Thus, the present system provides a plurality of benefits, and represents a groundbreaking advancement in digital banking, introducing a level of emotional intelligence that significantly enhances user experience. By integrating both voice and facial/body emotion recognition, the chatbot offers a more nuanced and empathetic approach to financial interactions, ensuring greater user engagement and promoting responsible financial decision-making.

The present subject matter may be used with any type of data storage, including but not limited to data enterprise data lakes (EDLs), databases (DBs), and Google stores, for example. While the present subject matter has been demonstrated using input data received from databases, any data source may be used by the present subject matter such as batch, real time or distributed data. In addition, the present system can support output of any type of data, in various embodiments, and may be use case dependent, with outputs to files, databases, fixed messages, scripts, batch, or published data. The present system provides for a software independent framework, which can run on Windows, Linux, Unix, or any other platform. The present system may provide one or more user interfaces, in various embodiments, such as graphic displays, custom configurations, spreadsheets, or any other type of user interface may be applied or provided on top of the present configuration. In various examples, the present system uses machine learning such as artificial intelligence to support data ingestion and processing. The present system may be used with any computer system. In various embodiments, the present system may be integrated with an application (or app) on a user's smartphone.

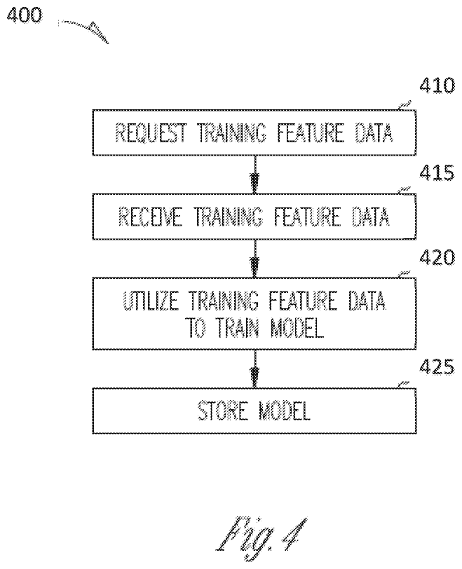

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1 and 4.

In various embodiments, the present system may use a mix of both structured computing and machine learning. In other embodiments, the present system may use machine learning without structure, and based on how a user is interacting with it, providing a further use for the guardrails of the present system.

The machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. In various examples, the artificial intelligence includes a large language model (LLM). Other types of machine learning models may be used without departing from the scope of the present subject matter.

Various embodiments include a non-transitory computer-readable storage medium, the non-transitory computer-readable storage medium including instructions that, when executed by computers, cause the computers to perform operations including the methods of FIGS. 1 and 4. In various examples, implementing additional security requirements for the transaction includes limiting an amount of the transaction. Implementing additional security requirements for the transaction includes delaying the transaction, in some examples. In various embodiments, implementing additional security requirements for the transaction includes implementing an additional security review of the transaction. Implementing additional security requirements for the transaction includes providing a notification to the user, in some embodiments.

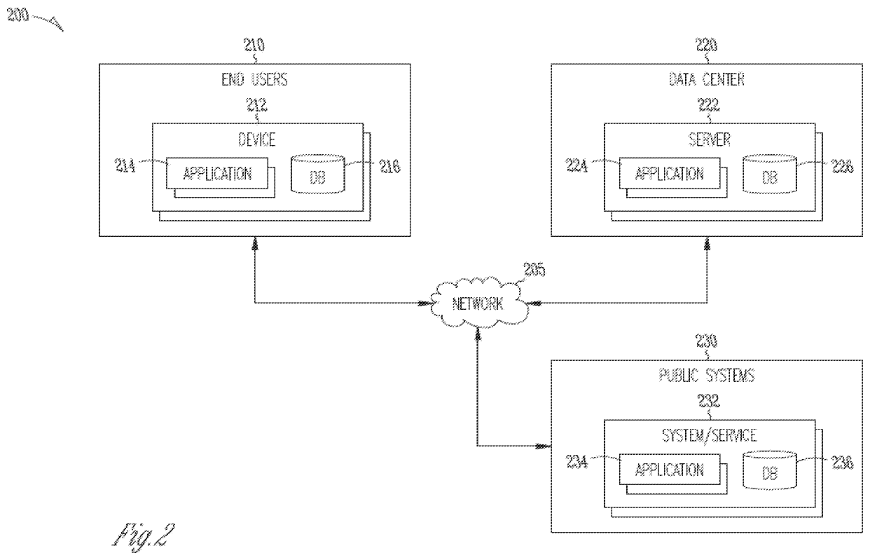

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 800 as described below. The end-user computing devices 212 may comprise applications 214 that are either designed to execute in a stand-alone manner, or interact with other applications 214 located on the device 212 or accessible via the network 205. These devices 212 may also comprise data stores 216 that holds data locally, the data being potentially accessible by the local applications 214 or by remote applications.

The system 200 may also include one or more data centers 220. A data center 220 may be a server 222 or the like associated with a business entity that an end user 210 may interact with. The server 222 or other portions of the distributed system may create and manage the system for emotionally adaptive financial chatbots, such as by performing operations including the methods of FIG. 1, in various embodiments. The business entity may be a computer service provider, as may be the case for a cloud services provider, or it may be a consumer product or service provider, such as a financial institution. The data center 220 may comprise one or more applications 224 and databases 226 that are designed to interface with the applications 214 and data stores 216 of end-user devices 212. Data centers 220 may represent facilities in different geographic locations where the servers 222 may be located. Each of the servers 222 may be in the form of a machine(s) 800.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 800.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

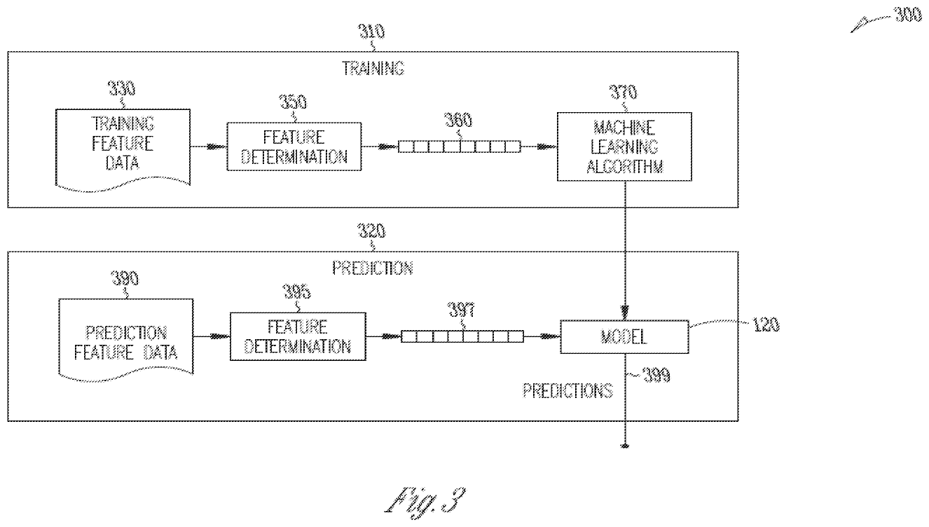

FIG. 3 shows an example machine learning system 300 according to some examples of the present disclosure. The machine learning system 300 may be implemented in whole or in part by one or more computing devices. In some examples, the training component 310 may be implemented by a different device than the prediction component 320. In these examples, the model 120 may be created on a first machine and then sent to a second machine. In various examples, the machine learning system 300 may be used generally for emotionally adaptive financial chatbots.

Machine learning system 300 utilizes a training component 310 and a prediction component 320. Training component 310 inputs training feature data 330 into feature determination component 350. The training feature data 330 may include data determined to be predictive of a user's emotional or financial state. Categories of training feature data may include speech data, facial image data financial data, user portfolio data, tracked user data, input user data, news articles, social media data, other third-party data, or the like. Specific training feature data and prediction feature data 390 may include, for example one or more of: current tracked user data, past tracked user data, and the like.

Feature determination component 350 selects training vector 360 from the training feature data 330. The selected data may fill training vector 360 and comprises a set of the training feature data that is determined to be predictive of a user's emotional state. In some examples, the tasks performed by the feature determination component 350 may be performed by the machine learning algorithm 370 as part of the learning process. Feature determination component 350 may remove one or more features that are not predictive of emotionally adaptive financial chatbots to train the model 120. This may produce a more accurate model that may converge faster. Information chosen for inclusion in the training vector 360 may be all the training feature data 330 or in some examples, may be a subset of all the training feature data 330.

In other examples, the feature determination component 350 may perform one or more data standardization, cleanup, or other tasks such as encoding non numerical features. For example, for categorical feature data, the feature determination component 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction component 320, prediction feature data 390 may be input to the feature determination component 395. The prediction feature data 390 may include the data described above for the training feature data, but for a specific items such as a user's current emotional state. In some examples, the prediction component 320 may be run sequentially for one or more items. Feature determination component 395 may operate the same, or differently than feature determination component 350. In some examples, feature determination components 350 and 395 are the same components or different instances of the same component. Feature determination component 395 produces vector 397, which is input into the model 120 to produce predictions 399. For example, the weightings and/or network structure learned by the training component 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training component 310 may operate in an offline manner to train the model 120. The prediction component 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training component 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

FIG. 4 illustrates a flowchart of a method 400 of training a model for emotionally adaptive financial chatbots, according to various embodiments. At operation 410 the training component (e.g., training component 310 as implemented by a model system) may request training feature data, from one or more systems. At operation 415 the training component may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions. In various examples, the model may be used for emotionally adaptive financial chatbots.

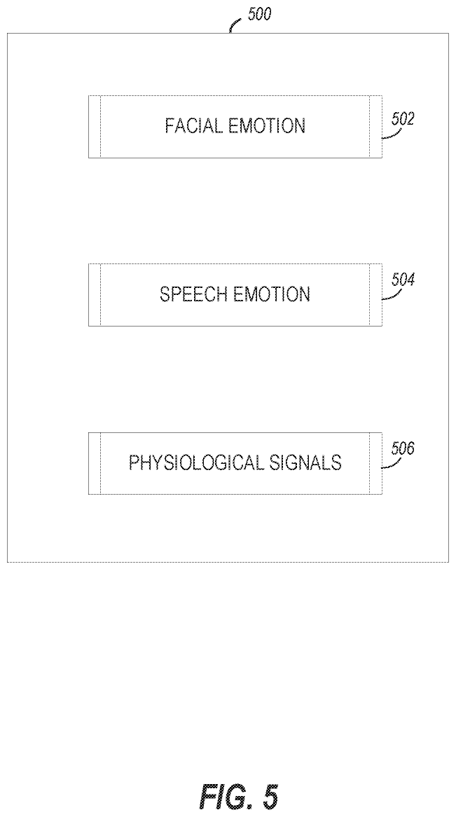

FIG. 5 illustrates a block diagram of a system for emotionally adaptive financial chatbots, according to various embodiments. A system 500 is provided that accurately detects a user's emotional state using a plurality of enhanced emotion recognition methodologies. In one example, the system 500 includes facial emotion recognition 502, speech emotion recognition 504, and/or physiological signal emotion recognition 506 to determine an emotional state of a user of a computer system using machine learning. Other types of emotion recognition may be used without departing from the scope of the present subject matter. In various aspects, the system may adapt an interaction style and/or implement additional transaction security requirements based on the recognized emotions of a user.

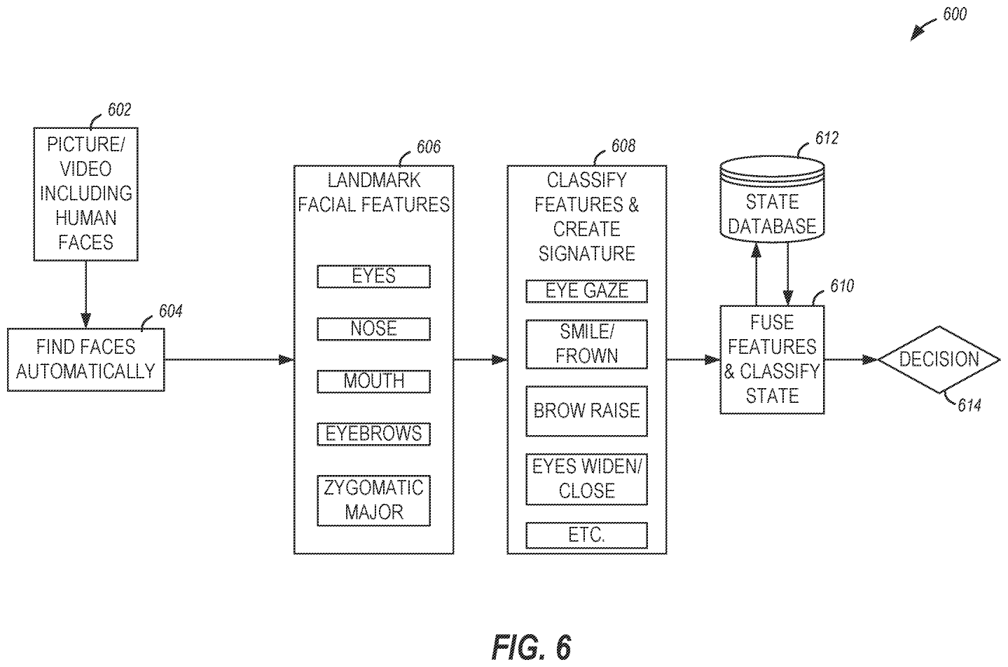

FIG. 6 illustrates a flow diagram of an emotionally adaptive system using facial features, according to various embodiments. In various examples, the present system uses a facial emotion recognition methodology to determine an emotional state of a user of a computer system using machine learning. The system 600 may include receiving a picture or video of a user's face 602, finding the user's face automatically 604, and identifying landmark facial features 606 of the user. Landmark facial features 606 may include, but are not limited to, the user's eyes, nose, mouth, eyebrows and/or zygomatic major. The system 600 may further include classifying features and creating signatures 608, including eye gaze, smile/frown, brow raise, eyes widen or close, and the like. The system 600 may access a state database 612 to fuse features and classify a user's emotional state 610, in various embodiments. The system 600 may include an output or decision 614 based on the user's classified emotional state, in various examples.

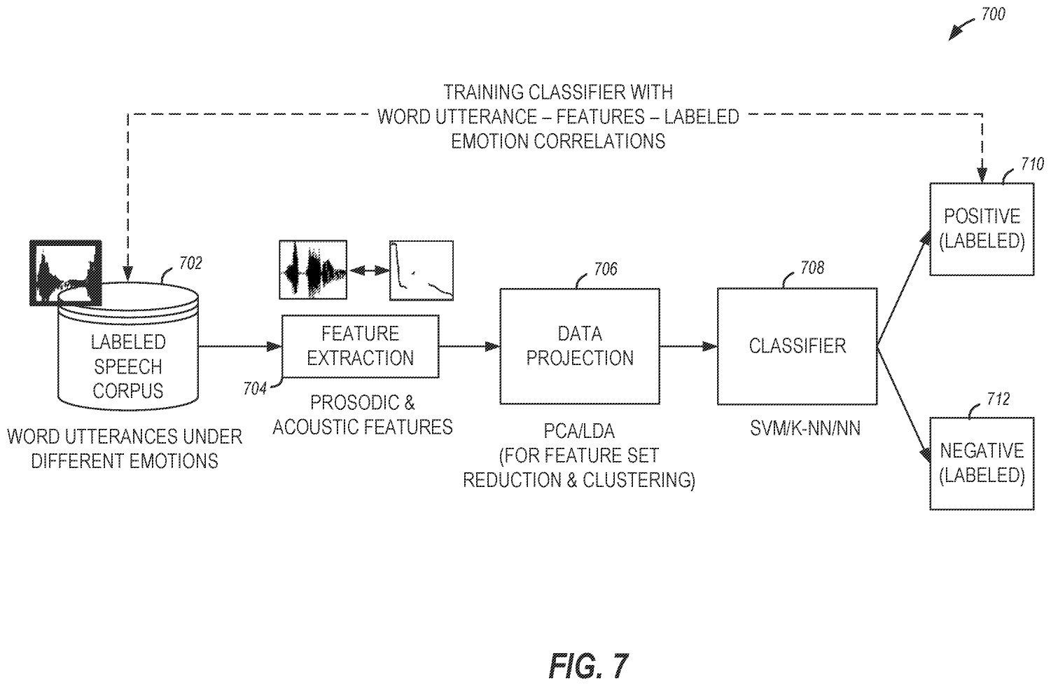

FIG. 7 illustrates a flow diagram of an emotionally adaptive system using speech features, according to various embodiments. In various examples, the present system uses a speech emotion recognition methodology to determine an emotional state of a user of a computer system using machine learning. The system 700 may include receiving a recording or audio feed of a user's speech, such as a labeled speech corpus 702 which may include word utterances under different emotions, in various embodiments. In various examples, the system 700 performs a feature extraction 704 to obtain prosodic and/or acoustic features, and uses data projection 706 for feature set reduction and clustering. The system 700 may then use a classifier 708 on the projection to classify and label the user's emotion based on the speech into a positive 710 or negative 712 emotion, according to various embodiments. The system 700 may include an output or decision based on the user's classified emotional state, in various examples.

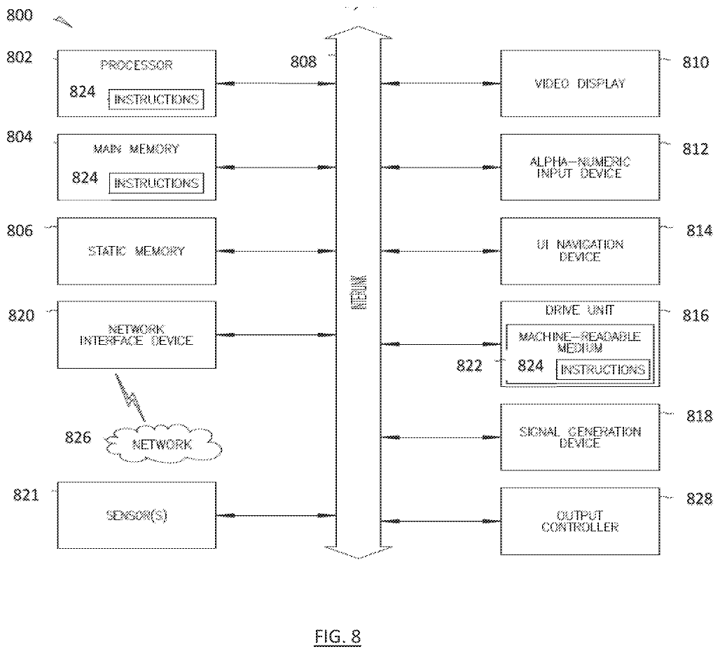

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may implement one or more of the training and prediction components 310, 320 (e.g., as software or dedicated hardware) and may be configured to perform the methods of FIGS. 1 and 4. The machine 800 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Components or modules are tangible entities (e.g., hardware) capable of performing specified operations and may be configured or arranged in a certain manner. In an example, circuits may be arranged (e.g., internally or with respect to external entities such as other circuits) in a specified manner as a component or module. In an example, the whole or part of one or more computer systems (e.g., a standalone, client or server computer system) or one or more hardware processors may be configured by firmware or software (e.g., instructions, an application portion, or an application) as a component or module that operates to perform specified operations. In an example, the software may reside on a machine readable medium. In an example, the software, when executed by the underlying hardware of the component or module, causes the hardware to perform the specified operations.

Accordingly, the term “component” or “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components or modules are temporarily configured, each of the components or modules need not be instantiated at any one moment in time. For example, where the components or modules comprise a general-purpose hardware processor configured using software, the general-purpose hardware processor may be configured as respective different components or modules at different times. Software may accordingly configure a hardware processor, for example, to constitute a particular component or module at one instance of time and to constitute a different component or module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### Other Notes and Examples

Example 1 is a computer-implemented method including receiving, by a computer system, authentication information from a user of the computer system, authenticating, by the computer system, the user for a transaction based on the received authentication information, detecting, by the computer system, an abnormal aspect of the transaction based on parameters of the transaction, upon detecting the abnormal aspect, determining, by the computer system using machine learning, an emotional state of the user, adapting, by the computer system, an interaction style with the user based on the determined emotional state of the user, receiving, by the computer system, an input from the user after adapting the interaction style, and implementing, by the computer system, additional security requirements for the transaction based on the detected abnormal aspect, the input from the user, and the determined emotional state.

In Example 2, the subject matter of Example 1 optionally includes wherein determining the emotional state of the user includes using voice analysis.

In Example 3, the subject matter of Example 2 optionally includes wherein determining the emotional state of the user includes analyzing voice tone of the user.

In Example 4, the subject matter of Example 2 optionally includes wherein determining the emotional state of the user includes analyzing speech patterns of the user.

In Example 5, the subject matter of Example 1 optionally includes wherein determining the emotional state of the user includes using computer vision.

In Example 6, the subject matter of Example 5 optionally includes wherein determining the emotional state of the user includes analyzing facial expressions of the user.

In Example 7, the subject matter of Example 5 optionally includes wherein determining the emotional state of the user includes analyzing body language of the user.

In Example 8, the subject matter of Example 1 optionally includes wherein the machine learning includes artificial intelligence.

In Example 9, the subject matter of Example 8 optionally includes wherein the artificial intelligence includes a large language model (LLM).

Example 10 is a system including: a computing system comprising one or more processors and a data storage system in communication with the one or more processors, wherein the data storage system comprises instructions thereon that, when executed by the one or more processors, causes the one or more processors to: receive authentication information from a user of the computer system, authenticate the user for a transaction based on the received authentication information, detect an abnormal aspect of the transaction based on parameters of the transaction, upon detecting the abnormal aspect, determine, using machine learning, an emotional state of the user, adapt an interaction style with the user based on the determined emotional state of the user, receive an input from the user after adapting the interaction style, and implement additional security requirements for the transaction based on the detected abnormal aspect, the input from the user, and the determined emotional state.

In Example 11, the subject matter of Example 10 optionally includes wherein using machine learning includes using a machine learning model including a neural network.

In Example 12, the subject matter of Example 10 optionally includes wherein using machine learning includes using a machine learning model including a long short-term memory (LSTM) network.

In Example 13, the subject matter of Example 10 optionally includes wherein using machine learning includes using a machine learning model including natural language processing (NLP).

In Example 14, the subject matter of Example 10 optionally includes wherein using machine learning includes using a machine learning model including an artificial intelligence (AI)-based knowledge tree.

In Example 15, the subject matter of Example 10 optionally includes wherein using machine learning includes using a machine learning model including a large language model (LLM).

Example 16 is a non-transitory computer-readable storage medium, the non-transitory computer-readable storage medium including instructions that, when executed by computers, cause the computers to perform operations of: receiving authentication information from a user of the computers, authenticating the user for a transaction based on the received authentication information, detecting an abnormal aspect of the transaction based on parameters of the transaction, upon detecting the abnormal aspect, determining, using machine learning, an emotional state of the user, adapting an interaction style with the user based on the determined emotional state of the user, receiving an input from the user after adapting the interaction style, and implementing additional security requirements for the transaction based on the detected abnormal aspect, the input from the user, and the determined emotional state.

In Example 17, the subject matter of Example 16 optionally includes wherein implementing additional security requirements for the transaction includes limiting an amount of the transaction.

In Example 18, the subject matter of Example 16 optionally includes wherein implementing additional security requirements for the transaction includes delaying the transaction.

In Example 19, the subject matter of Example 16 optionally includes wherein implementing additional security requirements for the transaction includes implementing an additional security review of the transaction.

In Example 20, the subject matter of Example 16 optionally includes wherein implementing additional security requirements for the transaction includes providing a notification to the user.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72 (b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A computer-implemented method comprising:
receiving, by a computer system, authentication information from a user of the computer system;
authenticating, by the computer system, the user for a transaction based on the received authentication information;
detecting, by the computer system, an abnormal aspect of the transaction based on parameters of the transaction;
upon detecting the abnormal aspect, determining, by the computer system using machine learning, an emotional state of the user;
adapting, by the computer system, an interaction style with the user based on the determined emotional state of the user;
receiving, by the computer system, an input from the user after adapting the interaction style; and
implementing, by the computer system, additional security requirements for the transaction based on the detected abnormal aspect, the input from the user, and the determined emotional state.

2. The method of claim 1, wherein determining the emotional state of the user includes using voice analysis.

3. The method of claim 2, wherein determining the emotional state of the user includes analyzing voice tone of the user.

4. The method of claim 2, wherein determining the emotional state of the user includes analyzing speech patterns of the user.

5. The method of claim 1, wherein determining the emotional state of the user includes using computer vision.

6. The method of claim 5, wherein determining the emotional state of the user includes analyzing facial expressions of the user.

7. The method of claim 5, wherein determining the emotional state of the user includes analyzing body language of the user.

8. The method of claim 1, wherein the machine learning includes artificial intelligence.

9. The method of claim 8, wherein the artificial intelligence includes a large language model (LLM).

10. A system comprising:
a computing system comprising one or more processors and a data storage system in communication with the one or more processors, wherein the data storage system comprises instructions thereon that, when executed by the one or more processors, causes the one or more processors to:
receive authentication information from a user of the computer system;
authenticate the user for a transaction based on the received authentication information;
detect an abnormal aspect of the transaction based on parameters of the transaction;
upon detecting the abnormal aspect, determine, using machine learning, an emotional state of the user;
adapt an interaction style with the user based on the determined emotional state of the user;
receive an input from the user after adapting the interaction style; and
implement additional security requirements for the transaction based on the detected abnormal aspect, the input from the user, and the determined emotional state.

11. The system of claim 10, wherein using machine learning includes using a machine learning model including a neural network.

12. The system of claim 10, wherein using machine learning includes using a machine learning model including a long short-term memory (LSTM) network.

13. The system of claim 10, wherein using machine learning includes using a machine learning model including natural language processing (NLP).

14. The system of claim 10, wherein using machine learning includes using a machine learning model including an artificial intelligence (AI)-based knowledge tree.

15. The system of claim 10, wherein using machine learning includes using a machine learning model including a large language model (LLM).

16. A non-transitory computer-readable storage medium, the non-transitory computer-readable storage medium including instructions that, when executed by computers, cause the computers to perform operations of:
receiving authentication information from a user of the computers;
authenticating the user for a transaction based on the received authentication information;
detecting an abnormal aspect of the transaction based on parameters of the transaction;
upon detecting the abnormal aspect, determining, using machine learning, an emotional state of the user;
adapting an interaction style with the user based on the determined emotional state of the user;
receiving an input from the user after adapting the interaction style; and
implementing additional security requirements for the transaction based on the detected abnormal aspect, the input from the user, and the determined emotional state.

17. The non-transitory computer-readable storage medium of claim 16, wherein implementing additional security requirements for the transaction includes limiting an amount of the transaction.

18. The non-transitory computer-readable storage medium of claim 16, wherein implementing additional security requirements for the transaction includes delaying the transaction.

19. The non-transitory computer-readable storage medium of claim 16, wherein implementing additional security requirements for the transaction includes implementing an additional security review of the transaction.

20. The non-transitory computer-readable storage medium of claim 16, wherein implementing additional security requirements for the transaction includes providing a notification to the user.
